(19) United States
(12) Patent Application Publication
(10) Pub. No.: US 2004/0253482 A1
(43) Pub. Date: Dec. 16, 2004

(54) Dual-layer magnetic medium with nonhalogenated binder system

(76) Inventors: James B. Philip JR., Mahtomedi, MN (US); Gary L. Featherstone, Maplewood, MN (US); Rebecca M. Martin, Woodbury, MN (US); Andrei Potanin, Woodbury, MN (US); Stanley C. Busman, North St. Paul, MN (US); Meng C. Hsieh, Woodbury, MN (US)

Correspondence Address: Imation Corp., PO Box 64898, St. Paul, MN, 55164-0898, US

(21) Appl. No.: 10/460,283

(22) Filed: Jun. 12, 2003

(51) Int. Cl. B32B 19/00

(52) U.S. Cl. 428/693; 428/694 BU; 428/694 B

(57) ABSTRACT

A dual-layer magnetic recording medium including a non-magnetic substrate having a front side and a back side, a lower support layer formed over the front side and a magnetic upper recording layer formed over the lower layer comprising at least one magnetic particle pigment formed over said lower support layer, at least one of said layers of the front coating comprising a polymer binder system for the pigment, such binder system comprising a hard resin component and a soft resin component, wherein the soft resin component comprises a polyurethane polymer, and the hard resin component comprises a nonhalogenated vinyl copolymer comprising a plurality of pendent nitrile groups, a plurality of pendent hydroxyl groups, and at least one pendent dispersing group.

### FIELD OF THE INVENTION

The present invention relates to magnetic recording media such as magnetic tapes, and more specifically to a dual-layer magnetic recording medium where at least one layer contains a polymeric binder system comprising a nonhalogenated vinyl polymer.

### BACKGROUND OF THE INVENTION

Magnetic recording media are widely used in audio tapes, video tapes, computer tapes, disks and the like. Magnetic media may use thin metal layers as the recording layers, or may comprise particulate magnetic compounds as the recording layer. The latter type of recording media employs particulate materials such as ferromagnetic iron oxides, chromium oxides, ferromagnetic alloy powders, and the like, dispersed in binders and coated on a substrate. In general terms, magnetic recording media generally comprise a magnetic layer coated onto at least one side of a non-magnetic substrate (e.g., a film for magnetic recording tape applications).

In certain designs, the magnetic coating (or “front coating”) is formed as a single layer directly onto a non-magnetic substrate. In an effort to reduce the thickness of this magnetic recording layer, an alternative approach has been developed to form the front coating as a dual layer construction, including a support layer (or “lower layer”) on the substrate and a reduced-thickness magnetic layer (or “upper layer”) formed directly on the support or lower layer. With this construction, the lower layer is typically non-magnetic or substantially non-magnetic, generally comprised of a non-magnetic powder and a binder. Conversely, the upper layer comprises a magnetic powder or pigment dispersed in a polymeric binder.

Magnetic tapes may also have a backside coating applied to the opposing side of the non-magnetic substrate in order to improve the durability, conductivity, and tracking characteristics of the media. As with the front coatings, the backside coatings are typically combined with a suitable solvent to create a homogeneous mixture, which is then coated onto the substrate, after which the coating is dried, calendered, if desired, and then cured.

Generally, front and back coatings, or “layers” of magnetic recording media include a binder composition. The binder composition performs such functions as dispersing the particulate materials, increasing adhesion between layers and to the substrate, improving gloss, and the like. As might be expected, the formulation specifics associated with the requisite upper layer, lower layer, and back coat, as well as coating of the same to an appropriate substrate, are highly complex, and vary from manufacturer to manufacturer; however, most binders include such materials as thermoplastic resins. Many polymeric binders have included a hard component and a soft component; polyurethane polymers have widely been used as the soft component. Copolymers including vinyl chloride and vinylidene chloride have been widely used as the hard component due to their compatibility with polyurethane and their physical properties. Unfortunately, vinyl chloride copolymers tend to degrade over time and release hydrochloric acid gas which can corrode the recording heads of equipment used with the magnetic medium and change the properties of the medium as well. It has, therefore, been desirable to create a polymeric binder system without the use of vinyl chloride or vinylidene chloride copolymers.

U.S. Pat. No. 5,501,903 discloses a polymeric binder system useful for a magnetic recording medium including a hard resin component comprising a nonhalogenated vinyl copolymer including a plurality of pendent nitrile groups, pendent hydroxyl groups, and at least one pendent dispersing group, preferably a quaternary ammonium moiety, and a soft polyurethane resin component having a phosphonate diester group. The binder is taught to provide good quality coatings having improved glass transition temperatures. However, monomeric components such as [2-(methacryloyloxy)ethyl]triethylammonium chloride still use chlorine as a counter ion in this system.

U.S. Pat. No. 5,510,187 discloses a polymeric binder system comprising a polyurethane resin containing a carboxylic acid group and a nonhalogenated vinyl copolymer including a plurality of pendent nitrile groups, pendent hydroxyl groups, and at least one pendent quaternary group.

U.S. Pat. No. 6,099,895 discloses a surface modifier for magnetic pigment, and a method for making a magnetic medium using a phosphonic acid surface modifier.

Copolymers based on vinyl chloride or vinylidene chloride have been widely used as the hard component due to their high glass transition temperatures, miscibility and compatibility with polyurethanes. However, halogenated materials have the potential of generating dioxins, and can produce hydrochloric acid, which can lead to corrosion of the medium and degradation of the recording unit “head.”

It would be desirable to further eliminate halogens from the polymeric binder system in order to generate a truly chloride free system to use as a binder for a magnetic medium.

### SUMMARY OF THE INVENTION

The current invention provides a dual-layer magnetic storage medium. Dual-layer magnetic recording media of the invention have a front coating comprising a lower support layer and an upper magnetic layer coated onto a substrate, wherein at least one layer of the front coating has a nonhalogenated polymer binder system, which contains no covalently bound halogen atoms. Specifically, the polymeric binder system comprises a nonhalogenated hard resin component and a soft resin component, wherein the hard resin component comprises a nonhalogenated vinyl copolymer comprising a plurality of pendent nitrile groups, a plurality of pendent hydroxyl groups, and at least one pendent dispersing group, and the soft resin component comprises a polyurethane polymer.

In one aspect, the invention provides a dual-layer magnetic medium comprising a substrate having coated thereon a support layer, and a magnetic layer or coating comprising at least one magnetic particle pigment, and a polymeric binder system for the magnetic particle pigment which comprises a nonhalogenated hard resin component and a soft resin component, wherein the hard resin component comprises a nonhalogenated vinyl copolymer comprising a plurality of pendent nitrile groups, a plurality of pendent hydroxyl groups, and at least one pendent dispersing group, and the soft resin component comprises a polyurethane polymer.

In another aspect, the invention further provides a dual-layer magnetic medium comprising a substrate having coated thereon a support layer, and a magnetic layer or coating comprising at least one magnetic particle pigment, wherein the support layer comprises a soft magnetic having a coercivity of less than about 300 Oe or nonmagnetic particle pigment, and a polymeric binder system which comprises a nonhalogenated hard resin component and a soft resin component, wherein the hard resin component comprises a nonhalogenated vinyl copolymer comprising a plurality of pendent nitrile groups, a plurality of pendent hydroxyl groups, and at least one pendent dispersing group, and the soft resin component comprises a polyurethane polymer.

In one embodiment, a dual-layer magnetic medium of the invention comprises a substrate having two major surfaces, a front surface and a back surface. On the front surface is coated a front coating comprising a lower support layer and an upper magnetic layer, at least one of said layers comprising a polymeric binder system comprising a soft resin component comprising a polyurethane polymer having a glass transition temperature of less than about 60° C., and a hard resin component comprising a nonhalogenated vinyl copolymer comprising a plurality of pendent nitrile groups, a plurality of pendent hydroxyl groups, and at least one pendent dispersing group.

In an alternative embodiment, a dual-layer magnetic medium of the invention comprises a substrate having two major surfaces, a front surface and a back surface. On the front surface is coated a front coating comprising a lower support layer and an upper magnetic layer, both of the layers in the front coating comprising a polymeric binder system comprising a soft resin component comprising a polyurethane polymer having a glass: transition temperature of less than about 60° C., and a hard resin component comprising a nonhalogenated vinyl copolymer comprising a plurality of pendent nitrile groups, a plurality of pendent hydroxyl groups, and at least one pendent dispersing group.

These terms when used herein have the following meanings.

1. The term “coating composition” means a composition suitable for coating onto a substrate.

2. The term “vinyl” when applied to a polymeric material means that the material comprises repeating units derived from vinyl monomers. When applied to a monomeric material, the term “vinyl” means that the monomer contains a moiety having a polymerizable carbon-carbon double bond.

3. The term “glass transition temperature” means the temperature at which the material changes from a hard, glassy material to a rubbery or viscous material. The term is frequently abbreviated as Tg.

4. The term “(meth)acryl-” means methacryl- or acryl-.

5. The terms “layer” and “coating” are used interchangeably to refer to a coated composition.

6. The term “nonhalogenated” means that the polymeric material contains no covalently bound halogen atoms.

All amounts and ratios herein are by weight, unless otherwise specifically noted.

### DETAILED DESCRIPTION OF THE INVENTION

The dual-layer magnetic recording medium of the invention comprises two layers on a front coating where at least one layer includes a particle (magnetic or nonmagnetic, depending on the layer) and a polymeric binder system that contains a hard polymer component and a soft polymer component. The soft polymer is preferably a polyurethane polymer and the hard polymer is a nonhalogenated vinyl copolymer.

In an exemplary embodiment, the hard resin component is a nonhalogenated, vinyl copolymer of monomers comprising: from about 5 to about 40 parts of (meth)acrylonitrile, from about 30 to about 80 parts of a nonhalogenated, nondispersing vinyl monomer, from about 1 to about 15 parts of a nonhalogenated, hydroxyl functional, vinyl monomer, and 0.125 to 10 parts by weight of a nonhalogenated vinyl monomer bearing a dispersing group.

The Magnetic Recording Layer

The upper layer of the medium is a magnetic recording layer. The magnetic recording layer has a thickness of from about 2 microinches (0.05 μm) to about 20 microinches (0.50 μm) in thickness, preferably from about 2 to about 15 microinches.

The primary magnetic pigment has a coercivity of at least about 1800 Oe, preferably at least about 2000 Oe. In one embodiment, the primary magnetic metal particle pigment has a coercivity of more than 2500 Oe.

The magnetic particles have a composition including, but not limited to, metallic iron and/or alloys of iron with cobalt and/or nickel, and magnetic oxides of iron, other elements, or mixtures thereof. Alternatively, the magnetic particles can be composed of hexagonal ferrites such as barium ferrites. In order to improve the required characteristics, the preferred magnetic powder may contain various additives, such as semi-metal or non-metal elements and their salts or oxides such as Al, Co, Y, Ca, Mg, Mn, Na, etc. The selected magnetic powder may be treated with various auxiliary agents before it is dispersed in the binder system, resulting in the primary magnetic pigment. Preferred pigments have an average length no greater than about 100 nanometers (nm), preferably no more than about 80 nm. Such pigments are readily commercially available from companies such as Toda, KDK, and Dowa Mining Company.

In addition to the preferred primary magnetic metal particle pigment described above, the metal particle pigment of the upper layer further includes carbon particles. A small amount, preferably less than 2%, of at least one large particle carbon material is also included, preferably a material that includes spherical carbon particles. The large particle carbon materials have a particle size on the order of from about 50 to about 500 nm, more preferably from about 100 to about 300 nm. Spherical large carbon particle materials are known and commercially available, and in commercial form can include various additives such as sulfur to improve performance. The remainder of the carbon particles present in the upper layer are small carbon particles, i.e., the particles have a particle length on the order of less than 100 nm, preferably less than about 75 nm.

The magnetic upper layer also includes an abrasive or head cleaning agent (HCA) component. One preferred HCA component is aluminum oxide. Other abrasive grains such as silica, ZrO₂, Cr₂O₃, etc., can also be employed, either alone or in mixtures with aluminum oxide or each other.

The upper layer further includes a binder system for the magnetic particles. In one exemplary embodiment, the binder system associated with the upper layer of magnetic recording media of the invention is a nonhalogenated binder system. The binder system incorporates at least one hard resin component and at least one soft resin component in conjunction with other components such as binders and surfactants used to disperse the HCA, a surfactant (or wetting agent), and one or more hardeners. The binder system of the upper layer includes a combination of a primary polyurethane resin and a nonhalogenated vinyl resin. Examples of useful polyurethanes include, but are not limited to polyester-polyurethane, polyether-polyurethane, polycarbonate-polyurethane, polyester-polycarbonate-polyurethane, and polycaprolactone-polyurethane. Polyurethane polymers are commercially available from companies such as Toboyo, Co, Ltd, Huntsman Polyurethanes, and the like.

The vinyl resin in such embodiment is a nonhalogenated vinyl copolymer. The term “nonhalogenated” means that the polymeric material contains no covalently bound halogen atoms. Thus, nonhalogenated excludes vinyl halide monomers such as vinyl chloride or vinylidene chloride and monomeric components of the copolymer. Useful nonhalogenated vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers. An exemplary nonhalogenated vinyl copolymer is a copolymer of monomers comprising 5 to 40 parts of (meth)acrylonitrile, 30 to 80 parts of one or more nonhalogenated, nondispersing, vinyl monomers, 1 to 15 parts by weight of a nonhalogenated, hydroxyl functional, vinyl monomer, and 0.25 to 10 parts of a nonhalogenated, vinyl monomer bearing a dispersing group. The primary polyurethane binder in this exemplary system is incorporated into the upper layer in an amount of about 4 to about 10 parts by weight, and preferably about 6 to about 8 parts by weight, based on 100 parts by weight of the magnetic upper layer pigment, and the nonhalogenated vinyl copolymer binder is incorporated in an amount of from about 7 to about 15 parts by weight, and preferably from about 10 to about 12 parts by weight, based on 100 parts by weight of the magnetic upper layer pigment.

In an alternative embodiment, the polymer binder system of the upper magnetic layer may include a vinyl chloride resin, a vinyl chloride-vinyl acetate copolymer, vinyl chloride-vinyl acetate-vinyl alcohol copolymer, vinyl chloride-vinyl acetate-maleic anhydride, and the like.

The binder system further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable.

The magnetic upper layer may further contain one or more lubricants such as a fatty acid and/or a fatty acid ester. The incorporated lubricant(s) exist throughout the front coating and, importantly, at the surface of the upper layer. The lubricant(s) reduces friction to maintain smooth contact with low drag, and protects the media surface from wear. Thus, the lubricant(s) provided in both the upper and lower layers are preferably selected and formulated in combination.

Preferred fatty acid lubricants include stearic acid that is at least 90 percent pure. Although technical grade acids and/or acid esters can also be employed for the lubricant component, incorporation of high purity lubricant materials ensures robust performance of the resultant medium. Other acceptable fatty acids include myristic acid, palmitic acid, oleic acid, etc., and their mixtures. The upper layer formulation can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination.

In a preferred embodiment, the lubricant is incorporated into the upper layer in an amount of from about 1 to about 10 parts by weight, and preferably from about 1 to about 5 parts by weight, based on 100 parts by weight parts of the magnetic upper layer pigment.

The binder system may also contain a conventional surfactant or wetting agent. Known surfactants, such as phenylphosphonic acid (PPA), 4-nitrobenzoic acid, and various other adducts of sulfuric, sulfonic, phosphoric, phosphonic, and carboxylic acids are acceptable. The wetting agent may also include azo compounds, including the acid form of chrome orange, as defined in pending U.S. application Ser. No. 10/328,498, filed Dec. 23, 2002, entitled “Magnetic Recording Medium Having a Low Molecular Weight Azo Dye Including an Aryl Group.”

The binder system may also contain a hardening agent such as isocyanate or polyisocyanate. In a preferred embodiment, the hardener component is incorporated into the upper layer in an amount of from about 2 to about 5 parts by weight, and preferably from about 3 to about 4 parts by weight, based on 100 parts by weight of the primary upper layer pigment.

The materials for the upper layer are mixed with the primary pigment and coated atop the lower layer. Useful solvents associated with the upper layer coating material preferably include cyclohexanone (CHO), with a preferred concentration of from about 5% to about 50%, methyl ethyl ketone (MEK) preferably having a concentration of from about 30% to about 90%, and toluene (Tol) of concentrations from about 0% to about 40%. Alternatively, other ratios can be employed, or even other solvents or solvent combinations including, for example, xylene, tetrahydrofuran, methyl isobutyl ketone, and methyl amyl ketone are acceptable.

The lower layer

The lower layer of a dual-layer magnetic tape is essentially non-magnetic and typically includes a non-magnetic or soft magnetic powder having a coercivity of less than about 300 Oe and a resin binder system. By forming the lower layer to be essentially non-magnetic, the electromagnetic characteristics of the upper magnetic layer are not adversely affected. However, to the extent that it does not create any adverse affect, the lower layer may contain a small amount of a magnetic powder.

The pigment or powder incorporated in the lower layer includes at least a primary pigment material and conductive carbon black. The primary pigment material consists of a particulate material, or “particle” selected from non-magnetic particles such as iron oxides, titanium dioxide, titanium monoxide, alumina, tin oxide, titanium carbide, silicon carbide, silicon dioxide, silicon nitride, boron nitride, etc., and soft magnetic particles having a coercivity of less than about 300 Oe. Optionally, these primary pigment materials can be provided in a form coated with carbon, tin, or other electroconductive material and employed as lower layer pigments. In a preferred embodiment, the primary lower layer pigment material is a hematite material (α-iron oxide), which can be acidic or basic in nature. Preferred alpha-iron oxides are substantially uniform in particle size, or a metal-use starting material that is dehydrated by heating, and annealed to reduce the number of pores. After annealing, the pigment is ready for surface treatment, which is typically performed prior to mixing with other layer materials such as alumina, carbon black and the like. Alpha-iron oxides are well known and are commercially available from Dowa Mining Company, Toda Kogyo, KDK, Sakai Chemical Industry Co., and others. The primary pigment preferably has an average particle size of less than about 0.25 μm, more preferably less than about 0.15 μm.

Conductive carbon black material provides a certain level of conductivity so as to prohibit the front coating from charging with static electricity and further improves smoothness of the surface of the upper magnetic layer formed thereon. The conductive carbon black material is preferably of a conventional type and is widely commercially available. In one preferred embodiment, the conductive carbon black material has an average particle size of less than about 20 nm, more preferably about 15 nm. In the case where the primary pigment material is provided in a form coated with carbon, tin or other electroconductive material, the conductive carbon black is added in amounts of from about 1 to about 5 parts by weight, more preferably from about 1.5 to about 3.5 parts by weight, based on 100 parts by weight of the primary lower layer pigment material. In the case where the primary pigment material is provided without a coating of electroconductive material, the conductive carbon black is added in amounts of from about 5 to about 18 parts by weight, more preferably from about 8 to about 12 parts by weight, based on 100 parts by weight of the primary lower layer pigment material. The total amount of conductive carbon black and electroconductive coating material in the lower layer is preferably sufficient to provide a resistivity at or below about 1×10⁹ ohm/cm².

The lower layer can also include additional pigment components such as an abrasive or head cleaning agent (HCA). One preferred HCA component is aluminum oxide. Other abrasive grains such as silica, ZrO₂, Cr₂O₃, etc., can be employed.

The binder system or resin associated with the lower layer preferably incorporates at least one binder resin, such as a thermoplastic resin, in conjunction with other resin components such as binders and, surfactants used to disperse the HCA, a surfactant (or wetting agent), and one or more hardeners. In one exemplary embodiment, the binder system of the lower layer includes a combination of a primary polyurethane resin and a nonhalogenated vinyl copolymer. Useful vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers. A preferred nonhalogenated vinyl copolymer is a copolymer of monomers comprising 5 to 40 parts of (meth)acrylonitrile, 30 to 80 parts of one or more nonhalogenated, nondispersing, vinyl monomers, 1 to 15 parts by weight of a nonhalogenated, hydroxyl functional, vinyl monomer, and 0.25 to 10 parts of a nonhalogenated, vinyl monomer bearing a dispersing group.

Examples of useful polyurethanes include polyester-polyurethane, polyether-polyurethane, polycarbonate-polyurethane, polyester-polycarbonate-polyurethane, and polycaprolactone-polyurethane. Resins such as bisphenol-A epoxide, styrene-acrylonitrile, and nitrocellulose may also be acceptable.

In a preferred embodiment, a primary polyurethane binder is incorporated into the lower layer in amounts of from about 4 to about 10 parts by weight, and preferably from about 6 to about 8 parts by weight, based on 100 parts by weight of the primary lower layer pigment. In a preferred embodiment, the nonhalogenated vinyl binder is incorporated into the lower layer in amounts of from about 7 to about 15 parts by weight, and preferably from about 10 to about 12 parts by weight, based on 100 parts by weight of the primary lower layer pigment.

In an embodiment where the lower layer comprises a nonhalogenated polymer binder system, the lower layer may include a vinyl chloride resin, a vinyl chloride-vinyl acetate copolymer, vinyl chloride-vinyl acetate-vinyl alcohol copolymer, vinyl chloride-vinyl acetate-maleic anhydride, and the like.

The binder system further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable.

The binder system may also contain a conventional surface treatment agent. Known surface treatment agents, such as phenylphosphonic acid (PPA), 4-nitrobenzoic acid, and various other adducts of sulfuric, sulfonic, phosphoric, phosphonic, and carboxylic acids are acceptable. The wetting agent may also include azo compounds, including the acid form of chrome orange, as defined in pending U.S. application Ser. No. 10/328,498, filed Dec. 23, 2002, entitled “Magnetic Recording Medium Having a Low Molecular Weight Azo Dye Including an Aryl Group.”

The binder system may also contain a hardening agent such as isocyanate or polyisocyanate. In a preferred embodiment, the hardener component is incorporated into the lower layer in amounts of from about 2 to about 5 parts by weight, and preferably from about 3 to about 4 parts by weight, based on 100 parts by weight of the primary lower layer pigment.

The lower layer may further contain one or more lubricants such as a fatty acid and/or a fatty acid ester. The incorporated lubricant(s) exist throughout the front coating and, importantly, at the surface of the upper layer. The lubricant(s) reduces friction to maintain smooth contact with low drag, and protects the media surface from wear. Thus, the lubricant(s) provided in both the upper and lower layers are preferably selected and formulated in combination. By way of background, conventional magnetic recording tape formulations employ technical grade fatty acids and fatty acid esters as the lubricant(s). It has been found that these technical grade lubricant materials contribute to formation of sticky debris in the front coating due to migration of impurities to the front coating surface. This debris, in turn, can lead to poor tape performance due to contamination of recording heads and other media transport surfaces, interference with lubricity of the medium in transport causing excessive frictional drag, and media wear.

In a preferred embodiment, the lower layer includes stearic acid that is at least 90 percent pure as the fatty acid. Although technical grade acids and/or acid esters can also be employed for the lubricant component, incorporation of high purity lubricant materials ensures robust performance of the resultant medium. Alternatively, other acceptable fatty acids include myristic acid, palmitic acid, oleic acid, etc., and their mixtures. The lower layer formulation can further include a fatty acid ester such as butyl stearate, isopropyl stearate, butyl oleate, butyl palmitate, butylmyristate, hexadecyl stearate and oleyl oleate. The fatty acids and fatty acid esters may be employed singly or in combination. In a preferred embodiment, the lubricant is incorporated into the lower layer in an amount of from about 1 to about 10 parts by weight, and preferably from about 1 to about 5 parts by weight, based on 100 parts by weight of the primary lower layer pigment.

The materials for the lower layer are mixed with the surface treated primary pigment and the lower layer is coated to the substrate. Useful solvents associated with the lower layer coating material preferably include cyclohexanone (CHO), with a preferred concentration of from about 5% to about 50%, methyl ethyl ketone (MEK) preferably having a concentration of from about 30% to about 90%, and toluene (Tol) of concentrations from about 0% to about 40%. Alternatively, other ratios can be employed, or even other solvents or solvent combinations including, for example, xylene, tetrahydrofuran, and methyl amyl ketone are acceptable.

Back Coat

The back coat is generally of a type conventionally employed, and thus primarily consists of a soft (i.e., Moh's hardness <5) non-magnetic particle material such as carbon black or silicon dioxide particles. In one embodiment, the back coat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 25 nm, whereas the secondary, large carbon component preferably has an average particle size on the order of from about 50 to about 300 nm.

As is known in the art, back coat pigments dispersed as inks with appropriate binders, surfactant, ancillary particles, and solvents are typically purchased from a designated supplier. In a preferred embodiment, the back coat binder includes at least one of a polyurethane polymer, a phenoxy resin, or nitrocellulose added in an amount appropriate to modify coating stiffness as desired.

Substrate

The substrate can be any conventional non-magnetic substrate useful as a magnetic recording medium support. Exemplary substrate materials useful for magnetic recording tapes include polyesters such as polyethylene terephthalate (PET), polyethylene naphthalate (PEN), a mixture of polyethylene terephthalate and polyethylene naphthalate; polyolefins (e.g., polypropylene); cellulose derivatives; polyamides; and polyimides. Preferably, polyethylene terephthalate or polyethylene naphthalate is employed.

Although specific embodiments have been described herein for purposes of description of the preferred embodiment, it will be appreciated by those of ordinary skill in the art that a wide variety of alternate and/or equivalent implementations calculated to achieve the same purposes may be substituted for the specific embodiments described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### EXAMPLES

### Examples 1-3

The following examples further illustrate the present invention, in which the amounts are listed as parts by weight (pbw). In Examples 1-3, the nonhalogenated vinyl copolymer resin is used in both the lower support layer and the upper magnetic layer. In Example 4, the nonhalogenated vinyl copolymer resin is used only in the upper magnetic layer. The composition of each example is listed below, along with the particle size of particulate components. In each composition, the hard resin is that nonhalogenated vinyl copolymer described in Example 5 of U.S. Pat. No. 6,099,895.

In the lower layer of Examples 1-3, the alpha-iron oxide has a particle size of 0.11 μm, a surface area of 65 m²/gm, and a pH of 9. The acid form of Chrome Orange is commercially available from Dudley Chemical Corporation, Lakewood, N.J., and the carbon black is available as Black Pearls™ 2000 A99, from Cabot Corp., Billerica, Mass. The soft resin is a polyurethane polymer available as UR7300, from Toyobo, Japan, and the alumina is HMT60A, available from Sumitomo Chemical Co., Japan.

In the upper magnetic layer of Examples 1-2, the ferromagnetic metal powder has a major axis length of about 75 nm, a surface area of about 57 m²/g, a coercivity of 2495 Oe, a pH of 9, and atom % composition of 49.6% Fe, 12% Co, 2.7% Al, 8.2% Y. The soft resin is a polyurethane polymer available as UR7300, from Toyobo, Japan, and the hard resin is as noted above. The alumina HCA is HIT60A, Sumitomo Chemical Co., Japan, and carbon black materials are carbon black 1, Sevacarb® MT-LS N-991, available from Columbian Chemicals, Atlanta, Ga., and carbon black 2, Raven™410, also available from Columbian Chemicals, Atlanta, Ga.

In Example 3, the ferromagnetic metal powder has a major axis length of 61 nm, a surface area of 63.6 m²/g, a coercivity of 2533 Oe, and atom % composition of Al/Fe=7.7 at %, Y/Fe=13.1%, Co/Fe=38.3 at %). The remaining ingredients are as listed for Examples 1 and 2.

### Example 1

| | |
|---|---|
| Lower Support Layer | |
| alpha-iron oxide | 88.18 pbw |
| Chrome Orange, acid form | 1.76 pbw |
| Hard resin | 9.88 pbw |
| Soft resin | 9.88 pbw |
| Carbon black | 6.17 pbw |
| Stearic acid | 1.32 pbw |
| Alumina HCA | 4.41 pbw |
| Methylethylketone | 118.05 pbw |
| Toluene | 70.83 pbw |
| Cyclohexanone | 47.22 pbw |
| Magnetic Upper Layer | |
| Ferromagnetic metal powder | 11.03 pbw |
| 4-Nitrobenzoic acid | 0.33 pbw |
| Hard resin | 0.90 pbw |
| Soft resin | 0.91 pbw |
| Carbon black 1 | 0.055 pbw |
| Carbon black 2 | 0.055 pbw |
| Stearic acid | 0.165 pbw |
| Alumina HCA | 0.88 pbw |
| Methylethylketone | 15.23 pbw |
| Toluene | 9.14 pbw |
| Cyclohexanone | 6.09 pbw |

For the lower support layer and upper magnetic layer, the various components were combined in a double planetary mixer followed by dispersing in a sand mill. Prior to coating, 0.892 pbw of butyl stearate, 6.92 pbw of a 55 wt % solution of polyisocyanate in methylethylketone (Mondur® CB55N, Bayer Corporation, Pittsburgh, Pa.), and 87.8 pbw of a 50:20:30 wt % solvent mixture of methylethylketone/cyclohexanone/toluene were added to the lower support layer. Also, prior to coating, 0.112 pbw of butyl palmitate, 0.64 pbw of a 55 wt % solution of polyisocyanate in methylethylketone (Mondur® CB55N, Bayer Corporation, Pittsburgh, Pa.), and 7.71 pbw of a 50:20:30 wt % solvent mixture of methylethylketone/cyclohexanone/toluene were added to the upper magnetic layer.

After filtering, the lower support layer and upper magnetic layer were coated onto a polyethylene naphthalate substrate having a thickness of 6.1 μm. After orienting the upper magnetic layer in a magnetic field while still wet, the coating was dried and calendered to give a nominal thickness of 1.5 μm for the lower support layer and 0.10 μm for the upper magnetic layer. After heat soaking at 60° C. for 24 hours, the coated film was slit to a width of 0.5 inches for further testing. The results for coercivity, squareness, switching field distribution, surface roughness, SNR skirt noise, and broadband SNR are given in Table 1.

### Example 2

| | |
|---|---|
| Lower Support Layer | |
| alpha-iron oxide | 88.18 pbw |
| Chrome Orange, acid form | 1.76 pbw |
| Hard resin | 9.88 pbw |
| Soft resin | 9.88 pbw |
| Carbon black | 6.17 pbw |
| Stearic acid | 1.32 pbw |
| Alumina HCA | 4.41 pbw |
| Methylethylketone | 115.45 pbw |
| Toluene | 69.27 pbw |
| Cyclohexanone | 46.18 pbw |
| Magnetic Upper Layer | |
| Ferromagnetic metal powder | 11.03 pbw |
| Chrome Orange, acid form | 0.44 pbw |
| Hard resin | 1.20 pbw |
| Soft resin | 0.63 pbw |
| Carbon black 1 | 0.055 pbw |
| Carbon black 2 | 0.055 pbw |
| Stearic acid | 0.165 pbw |
| Alumina HCA | 0.88 pbw |
| Methylethylketone | 15.4 pbw |
| Toluene | 9.25 pbw |
| Cyclohexanone | 6.16 pbw |

For each lower support layer and upper magnetic layer, various components were combined in a double planetary mixer followed by dispersing in a sand mill. Prior to coating, 0.892 pbw of butyl stearate, 6.91 pbw of a 55 wt % solution of polyisocyanate in methylethylketone (Mondur CB55N, Bayer Corporation, Pittsburgh, Pa.), and 13.8 pbw of a 50:20:30 wt % solvent mixture of methylethylketone/cyclohexanone/toluene were added to the lower support layer. Also, prior to coating, 0.113 pbw of butyl palmitate, 0.66 pbw of a 55 wt % solution of polyisocyanate in methylethylketone (Mondur CB55N, Bayer Corporation, Pittsburgh, Pa.), and 20.6 pbw of a 50:20:30 wt % solvent mixture of methylethylketone/cyclohexanone/toluene were added to the upper magnetic layer. After filtering, the lower support layer and upper magnetic layer were coated onto polyethylene naphthalate substrate having a thickness of 6.1 μm. After orienting the upper magnetic layer in a magnetic field while still wet, the coating was dried and calendered to give a nominal thickness of 1.5 μm for the lower support layer and 0.10 μm for the upper magnetic layer. After heat soaking at 60° C. for 24 hours, the coated film was slit to a width of 0.5 inches for further testing. The results for coercivity, squareness, switching field distribution, surface roughness, SNR skirt noise, and broadband SNR are given in Table 1.

### Example 3

| | |
|---|---|
| Lower Support Layer | |
| alpha-iron oxide | 88.18 pbw |
| Chrome Orange, acid form | 1.76 pbw |
| Hard resin | 9.88 pbw |
| Soft resin | 9.88 pbw |
| Carbon black | 6.17 pbw |
| Alumina HCA | 4.41 pbw |
| Methylethylketone | 114.11 pbw |
| Toluene | 68.47 pbw |
| Cyclohexanone | 45.65 pbw |
| Magnetic Upper Layer | |
| Ferromagnetic metal powder | 11.03 pbw |
| 4-Nitrobenzoic acid | 0.44 pbw |
| Hard resin | 1.07 pbw |
| Soft resin | 0.54 pbw |
| Carbon black 1 | 0.055 pbw |
| Carbon black 2 | 0.055 pbw |
| Stearic acid | 0.165 pbw |
| Alumina HCA | 0.88 pbw |
| Methylethylketone | 15.13 pbw |
| Toluene | 9.08 pbw |
| Cyclohexanone | 6.05 pbw |

For each lower support layer and upper magnetic layer, various components were combined in a double planetary mixer followed by dispersing in a sand mill. Prior to coating, 1.325 pbw stearic acid, 0.872 pbw of butyl stearate, 6.70 pbw of a 55 wt % solution of polyisocyanate in methylethylketone (Mondur CB55N, Bayer Corporation, Pittsburgh, Pa.), and 27.79 pbw of a 50:20:30 wt % solvent mixture of methylethylketone/cyclohexanone/toluene were added to the lower support layer. Also, prior to coating, 0.111 pbw of butyl palmitate, 0.56 pbw of a 55 wt % solution of polyisocyanate in methylethylketone (Mondur CB55N, Bayer Corporation, Pittsburgh, Pa.), and 0.64 pbw of a 50:20:30 wt % solvent mixture of methylethylketone/cyclohexanone/toluene were added to the upper magnetic layer. After filtering, the lower support layer and upper magnetic layer were coated onto polyethylene naphthalate substrate having a thickness of 6.1 μm. After orienting the upper magnetic layer in a magnetic field while still wet, the coating was dried and calendered to give a nominal thickness of 1.4 μm for the lower support layer and 0.10 μm for the upper magnetic layer. After heat soaking at 60° C. for 24 hours, the coated film was slit to a width of 0.5 inches for further testing. The results for coercivity, squareness, switching field distribution, surface roughness, SNR skirt noise, and broadband SNR are given in Table 1.

### Example 4

In the lower layer of Example 4, the alpha-iron oxide has a particle size of 0.11 μm, a surface area of 65 m²/gm and a pH of 9. The carbon black is available as Black Pearls™ 2000 A99, from Cabot Corp., Billerica, Mass. The soft resin is a polyurethane polymer available as L7525, from Toyobo, Japan, and the hard resin is Irocoat™ CA-151HT, available from Huntsman Polyurethanes, West Deptford, N.J. The alumina is HIT60A, available from Sumitomo Chemical Co., Japan.

In the upper magnetic layer of Example 4, the ferromagnetic metal powder has a major axis length of 61 nm, surface area of 63.6 m²/g, coercivity of 2533 Oe, and atom % of Al/Fe=7.7, Y/Fe=13.1, Co/Fe=38.3. The soft resin is a polyurethane polymer available as UR7300 from Toyobo, Japan, and the hard resin is the nonhalogenated vinyl copolymer described in Example 5 of U.S. Pat. No. 6,099,895. The alumina HCA is HIT60A, Sumitomo Chemical Co., Japan, and carbon black materials are carbon black 1, Sevacarb® MT-LS N-991, and carbon black 2, Raven™410, available from Columbian Chemicals, Atlanta, Ga.

| | |
|---|---|
| Lower Support Layer | |
| alpha-iron oxide | 22 pbw |
| Phenylphosphinic acid | 0.22 pbw |
| Hard resin | 3.23 pbw |
| Soft resin | 1.61 pbw |
| Carbon black | 1.54 pbw |
| Alumina HCA | 1.10 pbw |
| Methylethylketone | 29.1 pbw |
| Toluene | 17.46 pbw |
| Cyclohexanone | 11.64 pbw |
| Magnetic Upper Layer | |
| Ferromagnetic metal powder | 11.03 pbw |
| 4-Nitrobenzoic acid | 0.44 pbw |
| Hard resin | 1.07 pbw |
| Soft resin | 0.54 pbw |
| Carbon black 1 | 0.055 pbw |
| Carbon black 2 | 0.055 pbw |
| Stearic acid | 0.165 pbw |
| Alumina HCA | 0.88 pbw |
| Methylethylketone | 15.13 pbw |
| Toluene | 9.08 pbw |
| Cyclohexanone | 6.05 pbw |

For the lower support layer and upper magnetic layer, the components were combined in a double planetary mixer followed by dispersing in a sand mill. Prior to coating, 0.326 pbw stearic acid, 0.22 pbw of butyl stearate, 1.67 pbw of a 55 wt % solution of polyisocyanate in methylethylketone (Mondur CB55N, Bayer Corporation, Pittsburgh, Pa.), and 5.23 pbw of a 50:20:30 wt % solvent mixture of methylethylketone/cyclohexanone/toluene were added to the lower support layer. Also, prior to coating, 0.111 pbw of butyl palmitate, 0.56 pbw of a 55 wt % solution of polyisocyanate in methylethylketone (Mondur CB55N, Bayer Corporation, Pittsburgh, Pa.), and 0.64 pbw of a 50:20:30 wt % solvent mixture of methylethylketone/cyclohexanone/toluene were added to the upper magnetic layer. After filtering, the lower support layer and upper magnetic layer were coated onto polyethylene naphthalate substrate having a thickness of 6.1 μm. After orienting the upper magnetic layer in a magnetic field while still wet, the coating was dried and calendered to give a nominal thickness of 1.4 μm for the lower support layer and 0.10 μm for the upper magnetic layer. After heat soaking at 60° C. for 24 hours, the coated film was slit to a width of 0.5 inches for further testing. The results for coercivity, squareness, switching field distribution, surface roughness, SNR skirt noise, and broadband SNR are given in Table 1.

TABLE 1

| | Ex.1 | Ex.2 | Ex.3 | Ex.4 |
|---|---|---|---|---|
| Hc, Oersteds | 2560 | 2610 | 2706 | 2702 |
| SQ ratio | 0.934 | 0.90 | 0.889 | 0.876 |
| SFD | 0.29 | 0.35 | 0.37 | 0.41 |
| AFM Ra | 4.02 | 4.02 | 4.32 | 4.33 |
| SNRskirt noise | 27.9 | 28.6 | 27.7 | 27.9 |
| BBSNR | 25.6 | 26.5 | 25.4 | 24.5 |
| DPSI (40% Threshold | 14 | 17 | 116 | 119 |
| errors) | | | | |
| DPSI (60% Threshold | 84 | 75 | 513 | 546 |
| errors) | | | | |
| Output relative to reference | 6.6 | 5.3 | 5.76 | 5.01 |

Hc (magnetic coercivity), SQ (squareness ratio), and SFD (switching field distribution) were measured with an LDJ Model 7670 M-H meter. AFM surface roughness was measured with a Digital Instruments Multimode Scanning Probe Microscope, small stage, contact mode, 100×100 μm scan size, 3^{rd} order flatten, and reported as Ra surface roughness. SNRskirt noise refers to the ratio of the aggregate noise in a measurement bandwidth of about 2 MHz centered about the signal frequency used, when tested according to ECMA International Standard 319. BBSNR (broadband signal-to-noise ratio) is the ratio of average signal power to average integrated broad noise power of a tape clearly written at density TRD2, expressed in decibels (dB). BBSNR measures the area under the frequency curve from 4.5 KHz to 15.8 MHz. This value is obtained according to ECMA International Standard 319. DPSI, signal loss as dropouts per square inch, are reported at 40% and 60% threshold levels. A 40% threshold means that only 40% of the original signal remains. Signals having less than 40% of the amplitude are recorded as a dropout. The DPSI tester writes a single, continuous monotone at a fixed density and monitors the amplitude of the recorded signal. The testing was done at 70 inches per second, with an MR read head of 12 micron track width, at a recorded density of 100 kfci (kiloflux changes per inch), and the values are per 1000 feet of tape on one track.

What is claimed is:

1. A dual-layer magnetic recording medium comprising a non-magnetic substrate having a front side and a back side, a front coating on said substrate comprising a lower support layer formed over the front side and a magnetic upper recording layer comprising at least one magnetic particle pigment formed over said lower support layer, at least one of said layers of said front coating comprising a polymer binder system for the pigment, said binder system comprising a hard resin component and a soft resin component, wherein said soft resin component comprises a polyurethane polymer, and said hard resin component comprises a nonhalogenated vinyl copolymer comprising a plurality of pendent nitrile groups, a plurality of pendent hydroxyl groups, and at least one pendent dispersing group.

2. A dual-layer magnetic recording medium according to claim 1, wherein said magnetic upper layer comprises said polymer binder system.

3. A dual-layer magnetic recording medium according to claim 1, wherein said lower support layer comprises said polymer binder system.

4. A dual-layer magnetic recording medium, wherein both said magnetic upper layer and said lower support layer comprise a polymer binder system according to claim 1.

5. A dual-layer magnetic recording medium according to claim 1, wherein said polymer binder system comprises a polyurethane polymer having a glass transition temperature of less than about 60° C., and said hard resin component comprises a nonhalogenated vinyl copolymer comprising a plurality of pendent nitrile groups, a plurality of pendent hydroxyl groups, and at least one pendent dispersing group.

6. A dual-layer magnetic recording medium according to claim 5, wherein the said hard resin component is a nonhalogenated vinyl copolymer of monomers comprising from about 5 to about 40 parts of (meth)acrylonitrile, from about 30 to about 80 parts of a nonhalogenated, nondispersing vinyl monomer, from about 1 to about 15 parts of a nonhalogenated, hydroxyl functional, vinyl monomer, and from about 0.125 to about 10 parts by weight of a nonhalogenated vinyl monomer bearing a dispersing group.

7. A dual-layer magnetic recording medium according to claim 1, wherein the magnetic pigment particles have a coercivity of at least about 2000.

8. A dual-layer magnetic recording medium according to claim 1, wherein the magnetic pigment particles have a coercivity of at least about 2300.

9. A dual-layer magnetic recording medium according to claim 1, wherein the magnetic pigment particles have an average length no greater than about 100 nm.

10. A dual layer magnetic recording medium according to claim 1, wherein the magnetic pigment particles have an average length no greater than about 80 nm.

11. A dual layer magnetic recording medium according to claim 1, wherein the upper layer comprises a primary ferromagnetic pigment, aluminum oxide, a spherical large particle carbon material, a polyurethane binder, a nonhalogenated vinyl copolymer binder, a hardener, a fatty acid ester lubricant, and a fatty acid lubricant.

12. A dual-layer magnetic recording medium according to claim 1, wherein said lower support layer comprises a pigment powder selected from a non-magnetic or soft magnetic powder having a coercivity of less than about 300 Oe, and a polymer binder system therefor.

13. A dual-layer magnetic recording medium according to claim 12, wherein said polymer binder system for said lower support layer further comprises a nonhalogenated vinyl copolymer.

14. A dual-layer magnetic recording medium according to claim 12, wherein said lower support layer further includes a fatty acid ester lubricant, a fatty acid lubricant, and a conductive carbon black material dispersed in said binder.

15. A dual-layer magnetic recording medium according to claim 12, wherein said conductive carbon black comprises less than about 12 weight percent of said lower layer.

16. A dual-layer magnetic recording medium according to claim 1, further comprising a back coat coated on said back side of said substrate.

17. A dual-layer magnetic recording medium according to claim 16, wherein the back coat includes a carbon black pigment, a polyurethane binder, and at least one compound selected from phenoxy resin and nitrocellulose.

18. A magnetic recording medium according to claim 17, wherein the back coat further comprises carbon black, and a metal oxide selected from titanium dioxide, iron oxide, aluminum oxide, and a mixture thereof.
